(19) United States
(12) Patent Application Publication
(10) Pub. No.: US 2007/0144154 A1
(43) Pub. Date: Jun. 28, 2007

(54) Air filter with air flow segregation

(76) Inventors: William L. Keller, Clarkston, MI (US); Harold V. Rodabaugh, Davison, MI (US)

Correspondence Address: DELPHI TECHNOLOGIES, INC., M/C 480-410-202, PO BOX 5052, TROY, MI, 48007, US

(21) Appl. No.: 11/315,846

(22) Filed: Dec. 22, 2005

(51) Int. Cl. F01N 3/00; F02M 35/02

(52) U.S. Cl. 60/289; 123/198 E

(57) ABSTRACT

An air filter assembly for delivering clean air to primary and secondary components such as a vehicle engine and a catalytic converter of the vehicle, for example. Air flow sensors are calibrated to sense the amount of air flow going to the engine to ensure optimum engine performance. The air filter assembly segregates the air flow between the engine and catalytic converter in a manner that allows intermittent air flow to the secondary component without substantially affecting the continuous air flow to the primary component.

### TECHNICAL FIELD

The present invention relates to air filters and, more particularly, to an air filter having a segregation feature to provide air to a primary component such as a vehicle engine, and a secondary air component such as a catalytic converter of a vehicle, for example.

### BACKGROUND OF THE INVENTION

Gasoline engines need the proper mixture of clean air and fuel for optimum operation and efficiency. The clean air is transported to the engine by an air induction system consisting of a dirty air cavity exposed to outside air, an air filter cleaning element, and a clean air cavity that is attached to the air intake of the engine, typically with flexible air ducting. Outside air, which is considered “dirty air”, is pulled by the vacuum of the engine into the dirty air cavity and drawn through the air filter element. The air filter removes particulates from the dirty air before it passes through to the clean air cavity and on to the engine. The clean air flow to the engine is monitored and metered to ensure the proper air/fuel mixture for optimum engine performance and efficiency. These air monitoring/metering devices are calibrated based on the optimum air flow volume at known engine vacuum levels and are very sensitive to any deviations from the calibrated air flow rate.

Some vehicle components other than the engine also need clean air to operate efficiently (e.g., the catalytic converter) and the clean air cavity of the air filter assembly is a convenient source to access for this purpose. A normally-off secondary air pump cycles on when the secondary component requires the secondary air which results in a change to the air flow rate in the air induction system. If the air flow sensor reads an air flow rate that is not within the accepted the calibrated air flow rate, an error signal is triggered and engine performance and efficiency may thereby be compromised.

It would therefore be desirable to have an air filter design and method that segregates the clean air flow to the engine and a secondary air component such that when air flow is drawn by the secondary component, it does not negatively impact the calibrated air flow rate to the engine.

### SUMMARY OF THE INVENTION

The present invention addresses the above stated need by providing an air filter assembly having an air flow segregation feature that provides air to a primary component (e.g., an engine), and a secondary component (e.g., a catalytic converter). A typical air filter assembly includes an air filter housing and a filter element disposed therein which separates the housing into a dirty air cavity and clean air cavity on either side of the filter. A dirty air inlet port allows air to be drawn from the outside into the dirty air cavity side of the housing. When the engine is running, the engine creates a vacuum which draws the dirty air through the filter to the clean air cavity side of the filter housing. An air outlet port on the clean air cavity side of the housing delivers the clean air to the engine through appropriate ducting.

According to an aspect of the invention, a secondary air cavity is formed within the air filter assembly housing. The secondary air cavity is defined in part by secondary filter walls positioned in the filter which effectively separates the air filter into a primary air filter portion and a secondary air filter portion. The primary air filter portion of the filter cleans the air that is directed to a first clean air outlet leading to the primary component (e.g., the engine). The secondary air filter portion of the filter cleans the air that is directed to a second clean air outlet leading to the secondary component (e.g., the catalytic converter). The clean air cavity side of the housing also includes cavity walls which align with the filter walls to define a secondary clean air cavity that is segregated from the primary clean air cavity. The air flow is thus segregated beginning at the filter and continuing uninterrupted through the clean air cavity of the housing. As such, air flow that is drawn by the secondary component will not negatively impact the calibrated air flow rate to the primary component.

### BRIEF DESCRIPTION OF THE DRAWINGS

The present invention will now be described, by way of example, with reference to the accompanying drawings, in which:

FIG. 1 is an assembled, perspective view with a part broken away according to one embodiment of the inventive air filter assembly;

FIG. 2 is an exploded, perspective view of the air filter assembly of FIG. 1;

FIG. 3 is an enlarged, fragmented view showing particular details of the secondary air cavity of the air filter assembly of FIG. 1;

FIG. 4 is a fragmented, cross-sectional view as taken through the line 4-4 in FIG. 1; and

FIG. 5 is a fragmented, perspective view of the top cover of the air filter assembly of FIG. 1.

### DESCRIPTION OF THE PREFERRED EMBODIMENTS

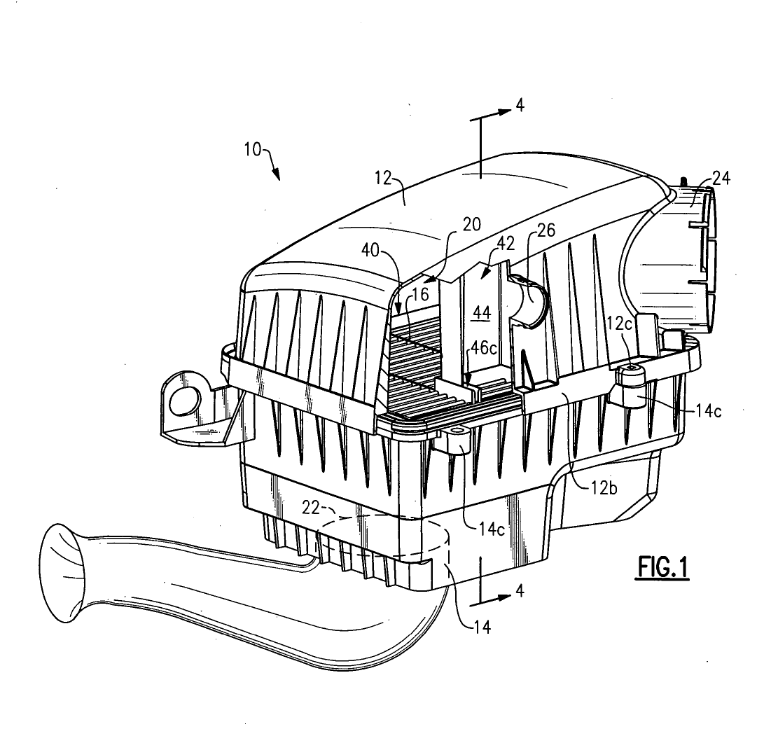

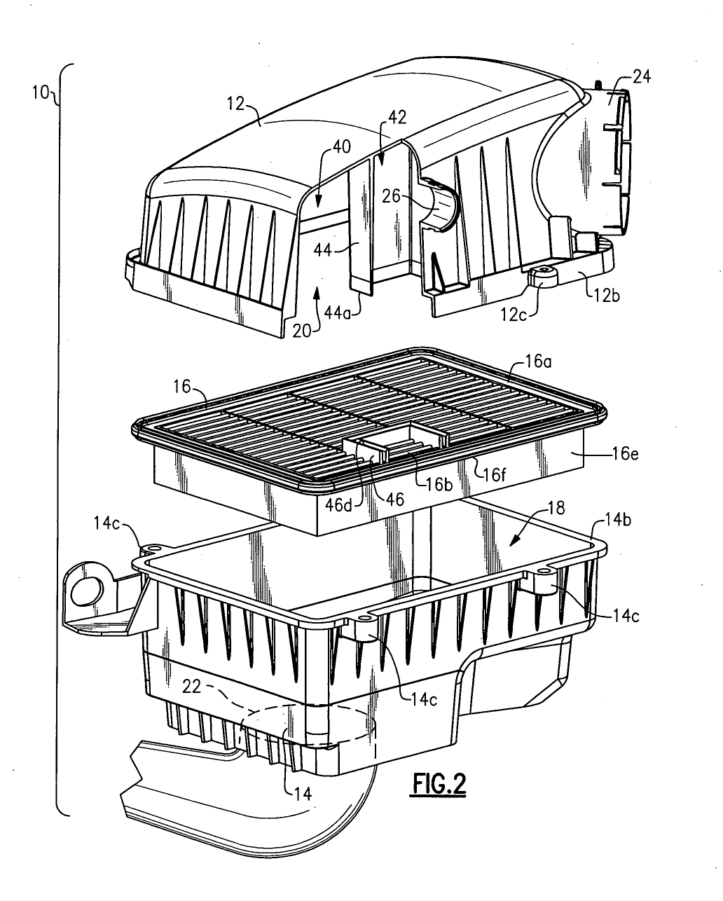

Referring now to the drawings, there is seen in FIGS. 1-5 an air filter assembly designated generally by the reference numeral 10. It is understood that the overall shape and design of assembly 10 is for description purposes only and the present invention is not to be limited thereby. In the embodiment shown and described herein, air assembly 10 is part of an automobile engine air induction system (not shown) although the present invention may be applied to air filter assemblies in other air filter applications.

Air assembly 10 includes a housing having upper and lower halves 12, 14, respectively. A filter 16 is positioned within the housing between the upper and lower halves 12, 14 and thereby defines a lower “dirty air” cavity 18 and upper “clean air” cavity 20. An air inlet port 22 is formed on lower housing half 14 wherethrough dirty air from the outside may pass into the filter assembly 10. Primary and secondary air outlets 24,26 are provided on upper housing half 12 with primary outlet 24 leading to the primary component requiring clean air, for example the vehicle engine (not shown). Secondary air outlet 26 leads to a secondary component requiring clean air, for example a catalytic converter (not shown). When the engine is running, the engine pulls a vacuum at primary outlet 24 and dirty air is drawn from the outside through inlet port 22 into the dirty air cavity 18 of the housing. Since the vacuum is located at primary outlet port 24 which is on the clean air side of the housing, the dirty air in cavity 18 is drawn upward through filter element 16 which captures particulate and thus passes clean air into the clean air cavity 20 of the housing.

The present invention segregates the air flow between the primary air outlet 24 and secondary air outlet 26. Clean air cavity 20 is thus segregated into two cavities; a primary clean air cavity 40 in fluid communication with the primary outlet port 24, and a secondary clean air cavity 42 in fluid communication with the secondary outlet port 26. This segregation also extends through the filter element 16 and thereby operates to provide clean air to both the primary and secondary air outlets as needed without any substantial affect on the calibrated air flow through the primary outlet port 24.

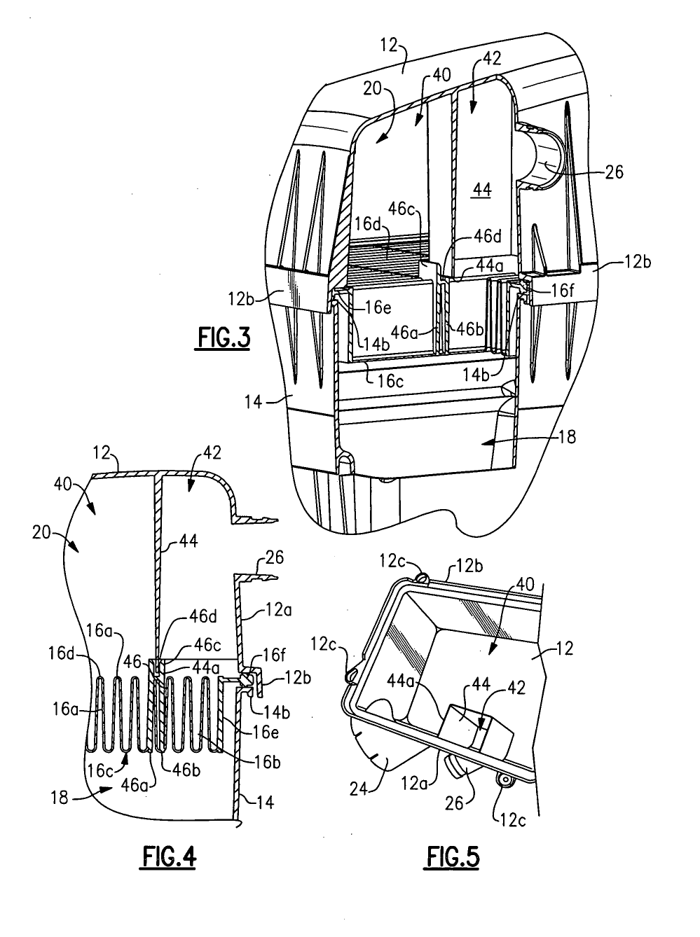

More particularly, the filter element 16 is segregated into a primary clean air portion 16a and a secondary clean air portion 16b by a filter wall 46 that extends entirely through the filter element 16 from the dirty air filter side 16c to the clean air filter side 16d thereof. In the illustrated embodiment, filter wall 46 has three walls with filter frame 16e forming a fourth wall to form a generally rectangular enclosure which effectively segregates secondary filter portion 16b from the primary filter portion 16a. It is understood, however, that the filter wall can be of any desired shape so long as the filter wall acts to segregate filter 16 into primary and secondary filter portions 16a, 16b, respectively. As seen best in FIG. 4, filter element 16 is pleated and filter wall 46 is bifurcated such that one of the filter pleats extends between the bifurcated segments 46a and 46b. The filter frame 16e including wall 46 and filter 16 may be attached to each other in any known manner such as by over-molding the two components, for example. In this regard, filter 16 may be made of any appropriate filter media such as a multi-layered synthetic, for example, which is over-molded onto the filter frame 16e including filter wall 46 which may be injected molded plastic, for example. The upper portion 46c of wall 46 is also bifurcated to form a channel 46d which extends above air filter 16 (e.g., by about 10 mm) into clean air cavity 20 for aligning and mating with the secondary air cavity wall in the upper housing half 12 as described below. It is noted that the particular configuration of filter 16 and filter wall 46 may vary according to the particular filter assembly design employed. For example, the filter element may be other than pleated (e.g., honey-comb) and the filter wall 46 may be a single planar wall.

The clean air cavity 20 within the housing upper half 12 is also segregated into a primary clean air cavity 40 and a secondary clean air cavity 42 by a secondary clean air cavity wall 44. Secondary clean air cavity wall 44, together with housing upper wall 12a (see FIG. 4), forms an enclosed secondary clean air cavity 42 that is thus segregated from the primary clean air cavity 40. The secondary air cavity wall 44 has a free edge 44a that is aligned with filter wall 46 such that when housing upper half 12 is attached to housing lower half 14, free edge 44a of secondary air cavity wall 44 may be press fit into channel 46d of filter wall 46. Thus, when the housing is fully assembled, secondary clean air cavity wall 44 is coextensive with filter wall 46 to provide a secondary air cavity 42 that extends substantially uninterrupted through filter 16. Furthermore, the filter frame outer edge 16f is captured between the outer edge 12b of upper housing half 12 and the outer edge 14b of lower housing half 14 (see FIG. 4). Screws (not shown) may be secured through aligned holes 12c, 14c in lower and upper housing halves 12, 14, respectively, to firmly secure the assembled air filter housing 10.

When the engine is running, a vacuum is drawn at primary outlet port 24 which draws outside dirty air through air inlet port 22 into dirty air cavity 18. Since the vacuum is originating at outlet port 24, the primary clean air cavity 40 of the clean air cavity 20 which is in fluid communication with primary outlet port 24 draws the dirty air from dirty air cavity 18, through primary filter portion 16a and into the primary clean air cavity portion 40 where the now clean air may exit the housing at primary outlet port 24 and travel to the engine. This clean air is monitored by calibrated sensors (not shown) located downstream of primary outlet port 24. As is well known to those skilled in the art, the air flow sensors are calibrated to predetermined air flow rates that correspond to the prevailing engine condition to achieve optimum engine performance.

Upon a secondary component requiring clean air, a secondary vacuum source such as an air pump (not shown) draws a vacuum at secondary outlet port 26 causing dirty air to be drawn from dirty air cavity 18 through secondary filter portion 16b and into secondary clean air cavity 42. The now clean air in air cavity 42 may exit the housing at secondary outlet port 26 and travel to the secondary component requiring clean air (e.g., the catalytic converter). It is noted that the secondary component requiring the clean air may require clean air only intermittently with respect to the primary component. The secondary vacuum source may therefore cycle on and off while the engine is continuously running. Since the secondary air cavity 42 is effectively segregated from the primary clean air cavity 40, the air flow and sensors monitoring the clean air downstream of primary outlet 24 are not substantially affected (i.e., they do not sense a substantial change in air flow volume in an amount that would trigger an out-of-calibration error signal) and clean air may flow to both the engine and the secondary component without interruption.

In the presently illustrated embodiment of the invention, the primary clean air cavity 40 and primary air outlet port 24 are much larger than the secondary clean air cavity 44 and secondary air outlet port 26. This is because a secondary component (e.g., the catalytic converter) requires much less of a clean air flow rate than the engine. The proportion between the primary and secondary cavities and outlet ports will therefore vary depending on the specific application of the air assembly 10 and may be readily determined by those skilled in the art without undue experimentation.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An air filter assembly for delivering filtered air to a primary component and a secondary component, said air filter assembly comprising:
a) a housing;
b) an air filter positioned within said housing and defining a clean air cavity and a dirty air cavity within said housing;
c) a filter wall attached to said filter and defining a primary air filter portion and a secondary air filter portion segregated from said primary air filter portion;
d) a clean air cavity wall attached to said housing within said clean air cavity, said cavity wall segregating said clean air cavity into a primary clean air cavity and a secondary clean air cavity, said clean air cavity wall aligning with said filter wall such that said primary and secondary air filter portions are in fluid communication with said primary and secondary clean air cavities, respectively;
e) a primary air outlet port attached to said housing and in fluid communication with said primary clean air cavity whereby air may flow from said dirty air cavity through said primary filter portion and primary clean air cavity and out said primary outlet port to said primary component; and
f) a secondary air outlet port attached to said housing and in fluid communication with said secondary clean air cavity whereby air may flow from said dirty air cavity through said secondary air filter portion and secondary clean air cavity and out said secondary outlet port to said secondary component, whereby air flow through said primary outlet is calibrated to a predetermined flow rate and air flow through said secondary outlet port is intermittent with respect to the air flow through said primary outlet port and does not substantially affect said calibrated flow rate through said primary outlet port.

2. The air filter assembly of claim 1, wherein said primary component is a vehicle engine.

3. The air filter assembly of claim 2 wherein said secondary component is a catalytic converter.

4. The air filter assembly of claim 1 wherein said housing includes separable upper and lower halves, said clean air cavity located within said upper half and said dirty air cavity located within said lower half.

5. The air filter assembly of claim 4 and wherein said filter wall includes a channel extending into said clean air cavity and said cavity wall includes a free end that extends into said channel when said housing upper and lower halves are assembled together.

6. The air filter assembly of claim 1 wherein said filter wall includes a bifurcated portion having first and second segments and wherein said filter is pleated, one of said filter pleats extending between said first and second segments of the bifurcated portion of said filter wall.

7. The air filter assembly of claim 6 wherein said filter is over-molded to said filter wall.

8. The air filter assembly of claim 7 wherein said filter wall is attached to a filter frame attached to said filter, said filter frame having a edge captured between said upper and lower housing halves when in the assembled condition.

9. The air filter assembly of claim 8 wherein said filter frame defines a part of said secondary filter portion.

10. The air filter assembly of claim 8 wherein said filter wall is three-sided and said filter frame forms a fourth wall therewith such that said secondary filter portion is substantially rectangular shaped.

11. The air filter assembly of claim 1 wherein said primary clean air cavity is larger than said secondary clean air cavity.

12. The air filter assembly of claim 11 wherein said primary clean air outlet port is larger than said secondary clean air outlet port.

13. A method of segregating air flow in an air filter assembly for delivering filtered air to a primary component and a secondary component, said method comprising the steps of:
a) providing a housing;
b) providing an air filter positioned within said housing and defining a clean air cavity and a dirty air cavity within said housing;
c) providing a filter wall attached to said filter and defining a primary air filter portion and a secondary air filter portion segregated from said primary air filter portion;
d) providing a clean air cavity wall attached to said housing within said clean air cavity, said cavity wall segregating said clean air cavity into a primary clean air cavity and a secondary clean air cavity, said clean air cavity wall aligning with said filter wall such that said primary and secondary air filter portions are in fluid communication with said primary and secondary clean air cavities, respectively;
e) providing a primary air outlet port attached to said housing and in fluid communication with said primary clean air cavity whereby air may flow from said dirty air cavity through said primary filter portion and primary clean air cavity and out said primary outlet port to said primary component; and
f) providing a secondary air outlet port attached to said housing and in fluid communication with said secondary clean air cavity whereby air may flow from said dirty air cavity through said secondary air filter portion and secondary clean air cavity and out said secondary outlet port to said secondary component, whereby air flow through said primary outlet is calibrated to a predetermined flow rate and air flow through said secondary outlet port is intermittent with respect to the air flow through said primary outlet port and does not substantially affect said calibrated flow rate through said primary outlet port.

14. The method of claim 13, wherein said primary component is a vehicle engine.

15. The method of claim 14 wherein said secondary component is a catalytic converter.

16. The method of claim 13 wherein said housing includes separable upper and lower halves, said clean air cavity located within said upper half and said dirty air cavity located within said lower half.

17. The method of claim 16 and wherein said filter wall includes a channel extending into said clean air cavity and said cavity wall includes a free end that extends into said channel when said housing upper and lower halves are assembled together.

18. The method of claim 13 wherein said filter wall includes a bifurcated portion having first and second segments and wherein said filter is pleated, one of said filter pleats extending between said first and second segments of the bifurcated portion of said filter wall.

19. The method of claim 18 and further comprising the step of over-molding said filter to said filter wall.

20. The method of claim 19 and further comprising the step of attaching said filter wall to a filter frame attached to said filter, said filter frame having a edge captured between said upper and lower housing halves when in the assembled condition.

21. The method of claim 20 wherein said filter frame defines a part of said secondary filter portion.

22. The method of claim 21 wherein said filter wall is three-sided and said filter frame forms a fourth wall therewith such that said secondary filter portion is substantially rectangular shaped.

23. The method of claim 13 wherein said primary clean air cavity is larger than said secondary clean air cavity.

24. The method of claim 23 wherein said primary clean air outlet port is larger than said secondary clean air outlet port.
